(19) United States
(12) Patent Application Publication
(10) Pub. No.: US 2025/0379358 A1
(43) Pub. Date: Dec. 11, 2025

(54) WIRELESS COMMUNICATION DEVICE HAVING CONTROLLABLE RADIATION PATTERN AND RADIATION PATTERN CONTROL METHOD THEREOF

(71) Applicant: PIXART IMAGING INC., Hsin-Chu County (TW)

(72) Inventor: Ya-Jyun LI, Hsin-Chu County (TW)

(21) Appl. No.: 18/739,328

(22) Filed: Jun. 11, 2024

(51) Int. Cl. H01Q 3/24; H01Q 1/22; H01Q 1/48

(52) U.S. Cl. CPC H01Q 3/24; H01Q 1/22; H01Q 1/48

(57) ABSTRACT

There is provided a wireless communication device including a substrate, a ground plane, a main radiation source antenna, a passive radiation source and a switching device. The ground plane, the main radiation source antenna, the passive radiation source and the switching device are arranged on the substrate. The main radiation source antenna is coupled to the ground plane. The passive radiation source is connected to or not connected to the ground plane via the switching device to change an effective area and shape of the ground plane.

### FIELD OF THE DISCLOSURE

This disclosure generally relates to a wireless communication device and, more particularly, to a wireless communication device and a radiation pattern control method that change a grounding shape and area of an antenna using at least one switching device to accordingly control a radiation pattern of the antenna.

### BACKGROUND OF THE DISCLOSURE

The inconvenience of using a signal line to communicate between a peripheral device and a host is eliminated by using the wireless transmission technology. However, because the wireless peripheral device is made to have stronger functions, the data transmission amount is also increased at the same time. It is known that the performance degradation caused by the packet loss can be reduced by improving the transmission performance.

Traditionally, an omnidirectional antenna is used to receive wireless signals from all directions. However, depending on operational environment of the wireless peripheral device, e.g., including the operating position, user habit (e.g., dominant hand) a transmission path of signals may be blocked to degrade the transmission performance.

The information disclosed in this BACKGROUND is merely intended to increase understanding of the general background of the invention and should not be taken as an admission or in any way implied that the relevant information constitutes prior art that is already known to a person of ordinary skill in the art.

### SUMMARY

Accordingly, the present disclosure provides a wireless communication device and a radiation pattern control method thereof that detect a received signal strength to accordingly determine an area and a shape of a ground plane of an antenna to control a radiation pattern of the antenna to improve the transmission performance.

The present disclosure provides a wireless communication device including an RF SoC, a ground plane, a main radiation source antenna, a conductive metal and a switching device. The main radiation source antenna is coupled to the ground plane. The conductive metal is physically separated from the ground plane. The switching device is configured to electrically connect the conductive metal to the ground plane to change a grounding area and a grounding shape of the main radiation source antenna to accordingly control a radiation pattern of the main radiation source antenna.

The present disclosure further provides a wireless communication device including an RF SoC, a ground plane, a main radiation source antenna, a first conductive metal, a second conductive metal, a first switching device and a second switching device. The main radiation source antenna is coupled to the ground plane. The first conductive metal, the second conductive metal and the ground plane are physically separated from one another. The first switching device and the second switching device, configured to electrically conduct the first conductive metal to the ground plane and the second conductive metal to the ground plane, respectively, to change a grounding area and a grounding shape of the main radiation source antenna to accordingly control a radiation pattern of the main radiation source antenna, wherein the RF SoC is configured to determine conducting states of the first switching device and the second switching device according to signal strengths corresponding to every conducting combination of the first switching device and the second switching device.

The present disclosure further provides a radiation pattern control method of a wireless communication device. The wireless communication device includes an RF SoC, a ground plane, a main radiation source antenna, at least one conductive metal and at least one switching device. The radiation pattern control method includes the steps of: identifying, by the RF SoC, a first signal strength received by the main radiation source antenna; conducting the at least one switching device in a predetermined sequence to connect the at least one conductive metal to the ground plane upon the first signal strength being lower than a strength threshold; identifying, by the RF SoC, a second signal strength received by the main radiation source antenna after the at least one conductive metal is connected to the ground plane; and comparing, by the RF SoC, the first signal strength and the second signal strength to determine whether to continuously conduct the at least one switching device.

### BRIEF DESCRIPTION OF DRAWINGS

Other objects, advantages, and novel features of the present disclosure will become more apparent from the following detailed description when taken in conjunction with the accompanying drawings.

FIG. 1 is a schematic diagram of a wireless communication device according to one embodiment of the present disclosure.

FIG. 2 is a schematic diagram of arranging a wireless communication device on a substrate according to a first embodiment of the present disclosure.

FIG. 3 is a schematic diagram of arranging a wireless communication device on a substrate according to a second embodiment of the present disclosure.

FIG. 4 is a schematic diagram of arranging a wireless communication device on a substrate according to a third embodiment of the present disclosure.

FIG. 5 is a schematic diagram of arranging a wireless communication device on a substrate according to a fourth embodiment of the present disclosure.

FIG. 6 is a flow chart of a radiation pattern control method of a wireless communication device according to one embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide a wireless communication device that additionally arranges at least one conductive metal as a passive radiation source, and a radiation pattern control method of the wireless communication device. A radiation frequency system-on-chip (RF SoC) automatically selects an optimum radiation pattern according to different combinations of grounding shapes to accordingly reduce the possibility of packet loss to accordingly maintain the high performance of wireless transmission.

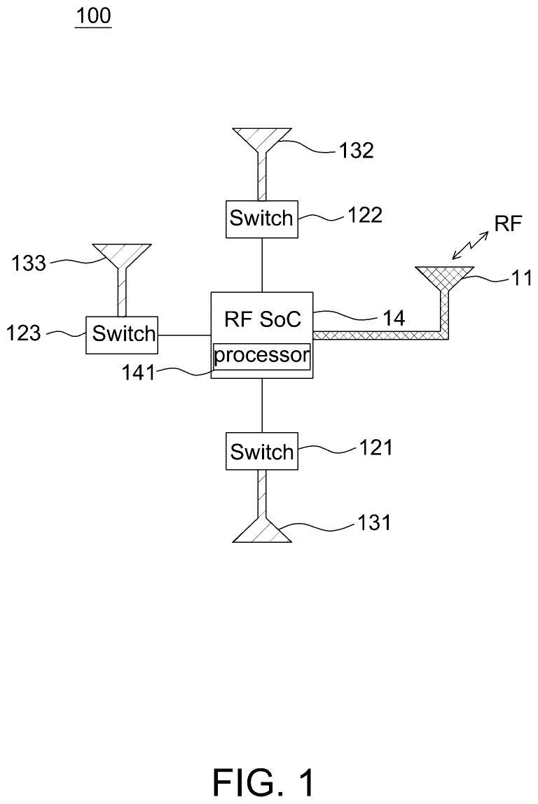

Please refer to FIG. 1, it is a schematic diagram of a wireless communication device 100 according to one embodiment of the present disclosure. The wireless communication device 100 is an electronic device capable of transmitting and receiving radio frequency signals RF, such as a wireless mouse, a wireless dongle, a wearable device or a portable device. The wireless communication device 100 includes a radio frequency system-on-chip (RF SoC) 14, a main radiation source antenna 11, at least one conductive metal (FIG. 1 showing three conductive metals 131, 132 and 133, but not limited to three) and at least one switching device (FIG. 1 showing three switching devices 121, 122 and 123, but not limited to three). The switching devices 121, 122 and 123 are RF switches such as SPDT, SP3T, SP4T, SP6T, SP8T, but not limited thereto. The wireless communication device 100 transmits and receives radio frequency signals RF via the main radiation source antenna 11. The main radiation source antenna 11 is an omnidirectional antenna or a directive antenna without particular limitations. The RF SoC 14 preferably includes a processor 141, e.g., a micro controller unit (MCU) or an application specific integrated circuit (ASIC) to identify a signal strength of the radio frequency signals RF, e.g., identifying the receiving signal strength indicator (RSSI) or signal-to-noise ratio (SNR).

In the present disclosure, the main radiation source antenna 11 has signal transmitting and receiving functions, but the at least one conductive metal does not have signal transmitting and receiving functions. The at least one conductive metal is used as a component to reflect or direct the radiation direction of the wireless communication device.

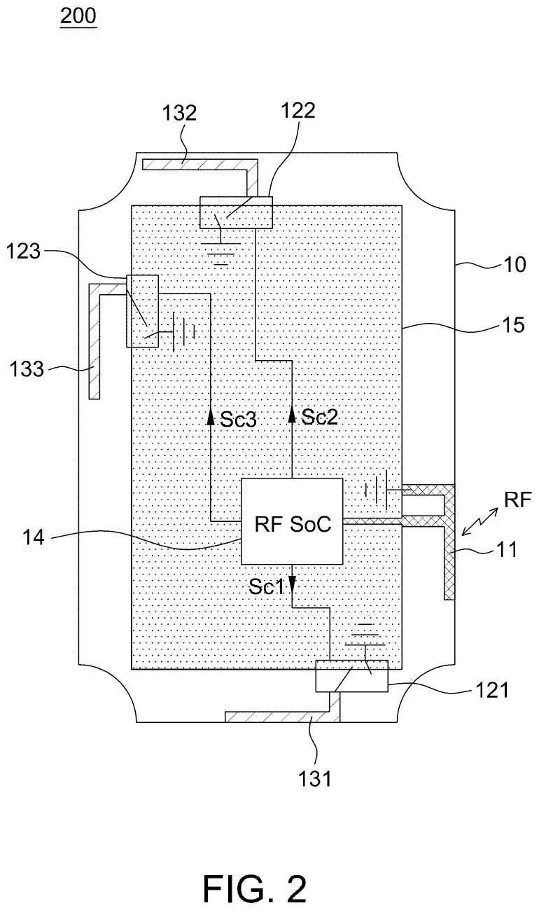

Please refer to FIG. 2, it is a schematic diagram of arranging a wireless communication device 200 on a substrate 10 according to a first embodiment of the present disclosure. The wireless communication device 200 includes an RF SoC 14, a ground plane 15, a main radiation source antenna 11, at least one conductive metal (e.g., 131, 132 and 133) and at least one switching device (e.g., 121, 122 and 123) arranged on the substrate 10. In one aspect, the main radiation source antenna 11 is constantly and directly connected to the ground plane 15, and an area and a shape of the ground plane 15 determine a radiation pattern of the main radiation source antenna 11. However in the present disclosure, the main radiation source antenna 11 is not limited to be directly connected to the ground plane 15, but is selected from any type of antenna known to the art without particular limitations. The at least one conductive metal is respectively connected to or disconnected from the ground plane 15 via the at least one switching device. The material and the shape of the ground plane 15 are not particularly limited as long as it can be used as ground of the substrate 10. The ground plane 15 is coupled to a system ground voltage or coupled to a reference voltage corresponding to different applications.

The at least one conductive metal is physically separated from the ground plane 15. The at least one switching device is respectively used to connect the at least one conductive metal to the ground plane 15 to change a grounding area and a grounding shape of the main radiation source antenna 11 to accordingly control a radiation pattern of the main radiation source antenna 11. For example, the first switching device 121 is used to control the first conductive metal 131 to electrically connect to or disconnect from the ground plane 15; the second switching device 122 is used to control the second conductive metal 132 to electrically connect to or disconnect from the ground plane 15; and the third switching device 123 is used to control the third conductive metal 133 to electrically connect to or disconnect from the ground plane 15.

In one aspect, the at least one conductive metal and the main radiation source antenna 11 are arranged on the same surface or different surfaces of the substrate 10. In the aspect that the substrate 10 is a multi-layer substrate, the at least one conductive metal and the main radiation source antenna 11 are arranged in the same layer or different layers of the multi-layer substrate; and the main radiation source antenna 11 and the ground plane 15 are arranged in the same layer or different layers of the multi-layer substrate.

The RF SoC 14 is used to determine the conducting state of the at least one switching device in an operation stage according to signal strengths corresponding to every conducting combination of the at least one switching device, e.g., by sending control signals Sc1 to Sc3 to respectively control the ON/OFF of the first switching device 121, the second switching device 122 and the third switching device 123. For example, when all the switching devices 121 to 123 are not conducted, the RF SoC 14 receives the radio frequency signal RF having a first signal strength from the main radiation source antenna 11. When the RF SoC 14 respectively controls one of the switching devices 121 to 123 to conduct, the RF SoC 14 receives the radio frequency signal RF having a second signal strength (including three strength values corresponding to conducting 121, 122 and 123 respectively) from the main radiation source antenna 11. When the RF SoC 14 respectively controls two of the switching devices 121 to 123 to conduct, the RF SoC 14 receives the radio frequency signal RF having a third signal strength (including three strength values corresponding to conducting 121&122, 121&123 and 122&123 respectively) from the main radiation source antenna 11. When the RF SoC 14 controls all of the switching devices 121 to 123 to conduct, the RF SoC 14 receives the radio frequency signal RF having a fourth signal strength from the main radiation source antenna 11, wherein the first signal strength to the fourth signal strength could be RSSIs or SNRs. The RF SoC 14 (e.g., the processor 141 thereof) compares all of the obtained signal strengths to determine an optimum strength and the corresponding conducted switching devices so as to control the conducting states of the switching devices 121 to 123. That is, the conducting states are determined according to the first, second, third and fourth signal strengths, which are influenced by a distance from a communication target of the wireless communication device 200, the obstacle(s) therebetween, and environmental noises. By selecting an optimum signal strength and conducting corresponding switching device(s), it is able to reduce the influence from these environmental reasons as much as possible.

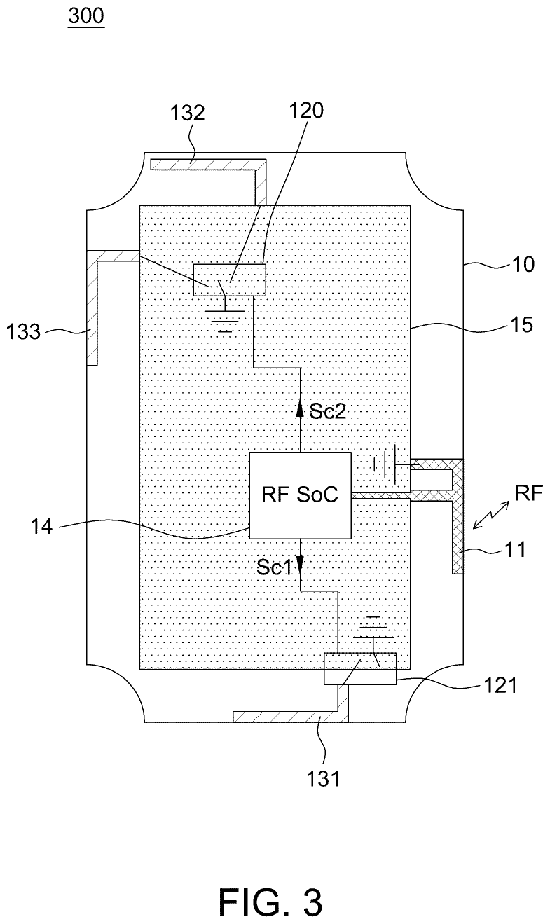

Please refer to FIG. 3, it is a schematic diagram of arranging a wireless communication device 300 on a substrate 10 according to a second embodiment of the present disclosure. The difference between the wireless communication device 300 and the wireless communication device 200 is that in the wireless communication device 300 the second conductive metal 132 and the third conductive metal 133 are connected to or disconnected from the ground plane 15 via the same switching device 120 so as to change a grounding area and a grounding shape of the main radiation source antenna 11 thereby controlling a radiation pattern of the main radiation source antenna 11. The arrangements of other components are identical to those in the wireless communication device 200, and thus details thereof are not repeated herein. That is, in the second embodiment, the switching device 120 is used to electrically connect the second conductive metal 132 to the ground plane 15 or electrically connect the third conductive metal 133 to the ground plane 15. In one aspect, the switching device 120 is simultaneously connect the second conductive metal 132 and the third conductive metal 133 to the ground plane 15 or disconnect the second conductive metal 132 and the third conductive metal 133 from the ground plane 15.

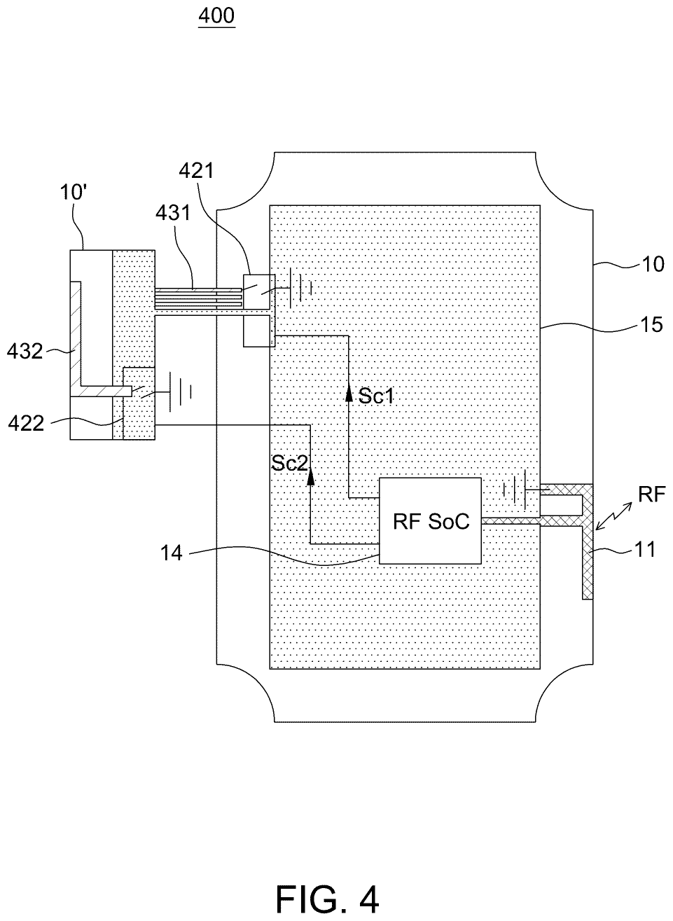

Please refer to FIG. 4, it is a schematic diagram of arranging a wireless communication device 400 on a substrate 10 according to a third embodiment of the present disclosure. The difference between the wireless communication device 400 and the wireless communication device 200/300 is that the wireless communication device 400 includes a first substrate 10 and a second substrate 10′ coupled to each other via a bus line (or flat cable). The ground plane 15 is arranged on the first substrate 10, the second substrate 10′ and the bus line, i.e. the wireless communication device 400 including one ground plane 15 extending from the first substrate 10 to the second substrate 10′ via the bus line. The RF SoC 14, the main radiation source antenna 11 and a switching device 421 are arranged on the first substrate 10. A conductive metal 432 and a switching device 422 are arranged on the second substrate 10′. A conductive metal 431 is arranged in the bus line. Similarly, the conductive metals 431 and 432 are physically separated from the ground plane 15, and the RF SoC 14 generates control signals Sc1 and Sc2 by comparing signal strengths (including conducting all of, non of and one of the switching devices 421 and 422) to respectively turning ON/OFF the switching devices 421 and 422 to change a grounding area and a grounding shape of the main radiation source antenna 11.

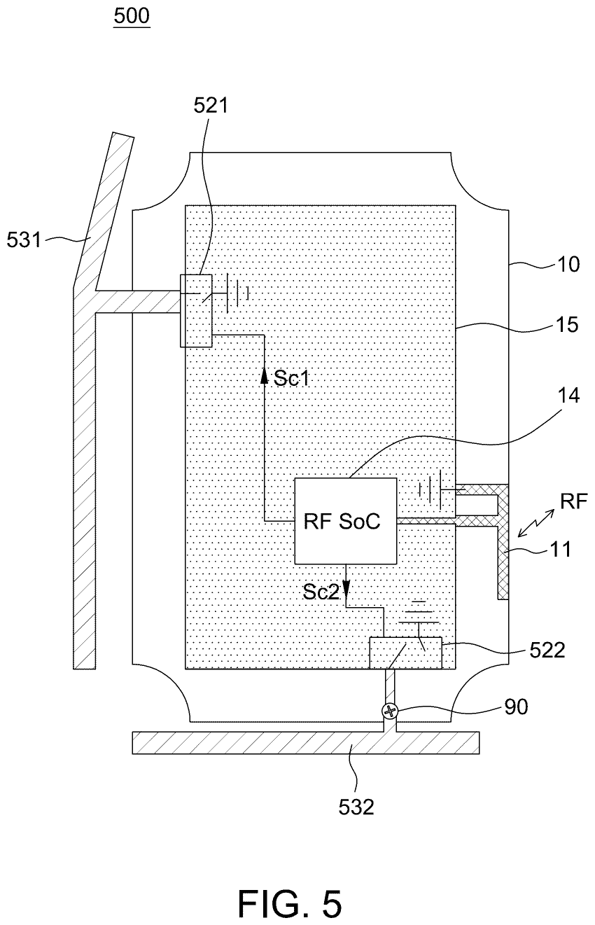

Please refer to FIG. 5, it is a schematic diagram of arranging a wireless communication device 500 on a substrate 10 according to a fourth embodiment of the present disclosure. The difference between the wireless communication device 500 and the wireless communication device 200/300 is that in the wireless communication device 500 the conductive metals 531 and 532 are respectively a part of a casing of the wireless communication device 500 and are not arranged on the substrate 10, e.g., 531 and 532 being attached to the substrate 10 using a screw 90 or other securing members. The RF SoC 14, the ground plane 15, the main radiation source antenna 11 and the at least one switching device (shown as 521 and 522 in FIG. 5) are arranged on the substrate 10.

The conductive metals mentioned in the above different embodiments are combinable. In other words, in the present disclosure the arrangement of the conductive metals are not particularly limited, e.g., arranged on the substrate 10 or to be separated from the substrate 10 (not limited to be on the casing), as long as the conductive metals may be electrically connected to a ground plane on the substrate 10 so as to achieve the purpose of changing a grounding area and a grounding shape of the main radiation source antenna 11 to accordingly control a radiation pattern of the main radiation source antenna 11.

In the present disclosure, the substrate is a printed circuit board or a flexible board without particular limitations.

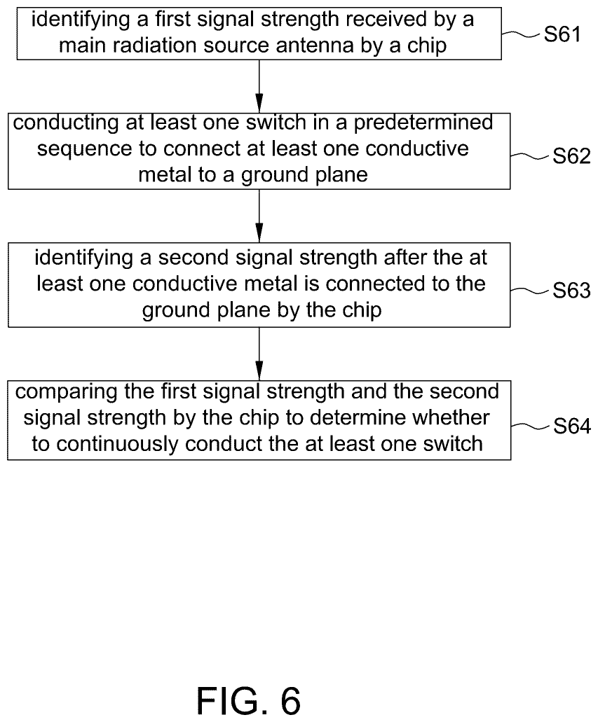

Please refer to FIG. 6, it is a flow chart of a radiation pattern control method of a wireless communication device 200, 300, 400 and 500 according to one embodiment of the present disclosure. The radiation pattern control method includes the steps of: identifying, by an RF SoC 14, a first signal strength received by a main radiation source antenna 11 (Step S61); conducting at least one switching device in a predetermined sequence to connect at least one conductive metal to a ground plane 15 upon the first signal strength being lower than a strength threshold (Step S62); identifying, by the RF SoC 14, a second signal strength received by the main radiation source antenna 11 after the at least one conductive metal is connected to the ground plane 15 (Step S63); and comparing, by the RF SoC 14, the first signal strength and the second signal strength to determine whether to continuously conduct the at least one switching device (Step S64).

Step S61: In an operation stage (e.g., a stage not changing the ON/OFF of the at least one switching device), the RF SoC 14 (e.g., processor 141 thereof) continuously identifies a first signal strength of the radio frequency signal RF received by the main radiation source antenna 11, e.g., identifying RSSI or SNR. It should be mentioned that the first signal strength is not limited to being acquired when all the switching devices are not conducted but is determined according to a previous radiation pattern adjustment. For example, in the first embodiment shown in FIG. 2, the first signal strength is a signal strength of the frequency radio signal RF received by the main radiation source antenna 11 when non of, at least one of, at least two of or all of the switching devices 121 to 123 are conducted.

Step S62: When the first signal strength is lower than a strength threshold (previously determined), it means that the wireless communication device 200/300/400/500 may have a position change or have an obstacle nearby to degrade the transmission performance thereof, and then the RF SoC 14 controls ON/OFF of the at least one switching device in a predetermined sequence, e.g., firstly conducting one of the switching devices 121 to 123 in a predetermined sequence, then conducting two of the switching devices 121 to 123 in a predetermined sequence and finally conducting all of the witching devices 121 to 123, but not limited to this sequence as long as all combinations or predetermined combinations are performed.

Step S63: The RF SoC 14 respectively obtains a second signal strength, e.g., RSSI or SNR corresponding to each of the different conducting combinations of the switching devices 121 to 123.

Step S64: Finally, the RF SoC 14 compares all of the obtained signal strengths to identify the maximum signal strength and the corresponding conducting states of the switching devices, and then said corresponding conducting states are used to transmit and receive the radio frequency signal RF in the operation stage, wherein content of the radio frequency signal RF is determined according to different applications without particular limitations.

It should be mentioned that the component positions in the drawings of every embodiment of the present disclosure are only intended to illustrate but not to limit the present disclosure.

It should be mentioned that the values, e.g., including the number of conductive metals and switching devices, mentioned in the present disclosure are only intended to illustrate but not to limit the present disclosure.

It should be mentioned that although the ground plane in the drawings of the present disclosure is shown as a rectangular plane, the present is not limited thereto. In other aspects, the ground plane has a mesh structure or has another shape, e.g., elliptical, trapezoidal, diamond, triangular shape. Furthermore, the ground plane is not limited to a two-dimensional structure.

As mentioned above, although the conventional peripheral device adopts an omnidirectional antenna to receive radio frequency signals, the transmission performance is degraded due to the transmission path being blocked by obstacles. Accordingly, the present disclosure further provides a wireless communication device (e.g., referring to FIGS. 2-5) and a radiation pattern control method thereof (e.g., referring to FIG. 6) that additionally arrange at least one conductive metal as a passive radiation source to be connected to substrate ground via at least one switching device. In this way, the grounding area and shape of a main radiation source antenna is automatically changed according to received signal strength to accordingly control a radiation pattern of the main radiation source antenna to be adapted to different operation scenarios thereby effectively improving the transmission performance and reducing the possibility of packet loss.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A wireless communication device, comprising:
a radio frequency system-on-chip (RF SoC);
a ground plane;
a main radiation source antenna, coupled to the ground plane;
a conductive metal, physically separated from the ground plane; and
a switching device, configured to electrically connect the conductive metal to the ground plane to change a grounding area and a grounding shape of the main radiation source antenna to accordingly control a radiation pattern of the main radiation source antenna.

2. The wireless communication device as claimed in claim 1, wherein the RF SoC is configured to
receive a first signal strength from the main radiation source antenna upon the switching device not being conducted,
receive a second signal strength from the main radiation source antenna upon the switching device being conducted, and
compare the first signal strength and the second signal strength to determine whether to continuously conduct the switching device.

3. The wireless communication device as claimed in claim 1, wherein the wireless communication device is a wireless mouse, a wireless dongle, a wearable device or a portable device.

4. The wireless communication device as claimed in claim 1, further comprising a substrate, wherein the RF SoC, the ground plane, the main radiation source antenna, the conductive metal and the switching device are arranged on the substrate.

5. The wireless communication device as claimed in claim 4, wherein the main radiation source antenna and the conductive metal are arranged on the same surface or different surfaces of the substrate.

6. The wireless communication device as claimed in claim 4, wherein the substrate is a multi-layer substrate, and the main radiation source antenna and the conductive metal are arranged in the same layer or different layers of the substrate.

7. The wireless communication device as claimed in claim 4, further comprising another conductive metal arranged on the substrate and physically separated from the ground plane and the conductive metal, wherein
the switching device is configured to electrically connect the conductive metal to the ground plane or electrically connect the another conductive metal to the ground plane to change the grounding area and the grounding shape of the main radiation source antenna.

8. The wireless communication device as claimed in claim 1, further comprising a first substrate and a second substrate coupled to each other via a bus line, wherein
the ground plane is arranged on the first substrate, the second substrate and the bus line,
the RF SoC and the main radiation source antenna are arranged on the first substrate, and
the conductive metal and the switching device are arranged on the second substrate.

9. The wireless communication device as claimed in claim 8, wherein
the bus line is further arranged with another conductive metal, and
the first substrate is further arranged with another switching device, which is configured to electrically connect the another conductive metal to the ground plane to change the grounding area and the grounding shape of the main radiation source antenna.

10. The wireless communication device as claimed in claim 1, further comprising a substrate, wherein
the RF SoC, the ground plane, the main radiation source antenna and the switching device are arranged on the substrate, and
the conductive metal is a part of a casing of the wireless communication device and is not arranged on the substrate.

11. A wireless communication device, comprising:
an RF SoC;
a ground plane;
a main radiation source antenna, coupled to the ground plane;
a first conductive metal and a second conductive metal, wherein the first conductive metal, the second conductive metal and the ground plane are physically separated from one another; and
a first switching device and a second switching device, configured to electrically conduct the first conductive metal to the ground plane and the second conductive metal to the ground plane, respectively, to change a grounding area and a grounding shape of the main radiation source antenna to accordingly control a radiation pattern of the main radiation source antenna,
wherein the RF SoC is configured to determine conducting states of the first switching device and the second switching device according to signal strengths corresponding to every conducting combination of the first switching device and the second switching device.

12. The wireless communication device as claimed in claim 11, further comprising a substrate, wherein the RF SoC, the ground plane, the main radiation source antenna, the first conductive metal, the second conductive metal, the first switching device and the second switching device are arranged on the substrate.

13. The wireless communication device as claimed in claim 11, further comprising a first substrate and a second substrate coupled to each other via a bus line, wherein
the ground plane is arranged on the first substrate, the second substrate and the bus line,
the RF SoC, the main radiation source antenna and the second switching device are arranged on the first substrate, and
the first conductive metal and the first switching device are arranged on the second substrate.

14. The wireless communication device as claimed in claim 13, wherein the second conductive metal is arranged in the bus line.

15. The wireless communication device as claimed in claim 11, further comprising a substrate, wherein
the RF SoC, the ground plane, the main radiation source antenna, the first switching device and the second switching device are arranged on the substrate, and
at least one of the first conductive metal and the second conductive metal is a part of a casing of the wireless communication device and is not arranged on the substrate.

16. A radiation pattern control method of a wireless communication device, the wireless communication device comprising an RF SoC, a ground plane, a main radiation source antenna, at least one conductive metal and at least one switching device, the radiation pattern control method comprising:
identifying, by the RF SoC, a first signal strength received by the main radiation source antenna;
conducting the at least one switching device in a predetermined sequence to connect the at least one conductive metal to the ground plane upon the first signal strength being lower than a strength threshold;
identifying, by the RF SoC, a second signal strength received by the main radiation source antenna after the at least one conductive metal is connected to the ground plane; and
comparing, by the RF SoC, the first signal strength and the second signal strength to determine whether to continuously conduct the at least one switching device.

17. The radiation pattern control method as claimed in claim 16, wherein the first signal strength and the second signal strength are received signal strength indicators.

18. The radiation pattern control method as claimed in claim 16, wherein
the ground plane and the main radiation source antenna are arranged on a substrate, and
the at least one conductive metal is arranged on or not arranged on the substrate.

19. The radiation pattern control method as claimed in claim 16, wherein
the main radiation source antenna has a signal emission function, and
the at least one conductive metal does not have the signal emission function.

20. The radiation pattern control method as claimed in claim 16, wherein
the main radiation source antenna is constantly connected to the ground plane, and
the at least one conductive metal is respectively connected to and disconnected from the ground plane via the at least one switching device.
